(19) United States
(12) Patent Application Publication
(10) Pub. No.: US 2025/0233957 A1
(43) Pub. Date: Jul. 17, 2025

(54) NETWORK DEVICE, INFORMATION PROCESSING METHOD, AND STORAGE MEDIUM

(71) Applicant: CANON KABUSHIKI KAISHA, Tokyo (JP)

(72) Inventor: Masaaki Sato, Tokyo (JP)

(21) Appl. No.: 18/978,050

(22) Filed: Dec. 12, 2024

(30) Foreign Application Priority Data
Jan. 12, 2024 (JP) 2024-003418

(51) Int. Cl. H04N 1/32; H04N 1/00; H04N 1/44

(52) U.S. Cl. CPC H04N 1/32101; H04N 1/00244; H04N 1/4406; H04N 2201/0094; H04N 2201/3202; H04N 2201/3278

(57) ABSTRACT

A network device is allowed to be connected to a server via a network. The network device collects log information for an event that occurs inside of the network device, accumulates the log collected information, and transmits the accumulated log information to the server via the network. In addition, the network device compares a time of occurrence for the event with a contract start time for a current ownership contract for the network device, and performing filtering such that log information for one or more events that occurred before the contract start time among the accumulated log information is not transmitted to the server.

### BACKGROUND OF THE INVENTION

### Field of the Invention

The present disclosure relates to a technology for information processing in a network device.

### Description of the Related Art

There is a need for a service that collects log information such as events or the like that occur on a networking device such as an image forming apparatus or the like on a storage serve that has been constructed on a cloud server, and performs analyses such as rapid protection, fault sign prediction, and the like. In order to realize this, it is necessary to frequently transmit a large volume of log information to the storage server via the internet from a network device that is being operated. However, in the case of a transmission format that performs transmission in real time to the storage server at the time of generation of the log information from the network device, the number of connections increases, and this becomes a cause for an increase in operating costs for the cloud. Therefore, generally, a transmission format is adopted that stores the log information within the network device at the time of generation of the log information, and batches together and transmits the log information that has been stored at an arbitrary timing.

In addition, there are cases in which the log information, which is necessary to collect, also includes personal information for a customer who is using the network device. In this case, it is necessary to perform the collection settings based on a contract related to the collection of information that has been signed with the customer at the unit of a device, and to logically separate the storage regions for the log information that has been collected for each contracted device even inside of the storage server. It is therefore necessary for the network device to securely send log information for which collection settings have been made, and at the same time, strict management is also necessary such that log information for which collection settings have not been made, which is outside of the contract, is not transferred.

In Japanese Patent Application Laid-open No. 2010-97524, a method is disclosed in which a client device that performs license acquisition is able to also access device information that was collected during a period in which a previous license contract was valid (usage history, damage history, or the like for the device) before a timing at which a new license is acquired. It thereby becomes possible for the client device that performs the license acquisition to collect information from after the license contract has been updated without excluding the device information from during the former licensing contract period and from during the period in which this license was expired.

However, the method that is disclosed in the above Patent Application Laid-open No. 2010-97524 does not assume a case in which there is a change in the owner of the device, such as a sales organization delivering the device to a customer, or a transfer of control of the device between two customers, or the like. In a case in which the contract for the same device is re-signed by a different owner, there is a particular need to appropriately manage information that has been stored within the device that was generated during the period for the previous contract.

### SUMMARY OF THE INVENTION

The present disclosure provides a technology that is able to appropriately manage information that has been generated during a period for a previous contract.

A network device according to one embodiment of the present disclosure is allowed to be connected to a server via a network. The network device comprises: a memory storing instructions; and a processor executing the stored instructions causing the network device to: collect log information for an event that occurs inside of the network device; accumulate the collected log information; transmit the accumulated log information to the server via the network; and compare a time of occurrence for the event with a contract start time for a current ownership contract for the network device, and perform filtering such that the log information for one or more events that occurred before the contract start time among the accumulated log information is not transmitted to the server.

Further features of the present disclosure will become apparent from the following description of exemplary embodiments (with reference to the attached drawings).

### BRIEF DESCRIPTION OF THE DRAWINGS

FIG. 1 is a diagram showing a configuration for a system according to one embodiment.

FIG. 2 is a diagram showing a hardware configuration that is shared by a server inside of the system.

FIG. 3 is a diagram showing a summary of the main hardware configuration for a network device.

FIG. 4 is a diagram showing a configuration for an information processing controller unit for the network device.

FIG. 5 is a diagram showing a software configuration of the network device.

FIG. 6 is a block diagram showing a software configuration of the server.

FIG. 7 is a portion of a sequence diagram showing processing for until device registration is performed and the collection of the log information for the network device begins.

FIG. 8 is the other portion of the sequence diagram of FIG. 7.

FIG. 9 is a portion of a sequence diagram showing processing for until an owner of the network device is changed and the collection of log information inside of the network device begins.

FIG. 10 is the other portion of the sequence diagram of FIG. 9.

FIG. 11 is a portion of a sequence diagram showing processing from the storage of trigger information until the transmission of log information to an upload region.

FIG. 12 is the other portion of the sequence diagram in FIG. 11.

FIG. 13 is a flowchart showing batch transmission of log information that has been stored on a buffer, which is executed by the network device.

FIG. 14 is a flowchart showing a continuation of FIG. 13.

### DESCRIPTION OF THE EMBODIMENTS

Below, embodiments of the present disclosure will be explained with references to the figures. Not all of the plurality of characteristics in the embodiment of the present disclosure are essential elements of the present disclosure, and a plurality of these characteristics may also be selectively combined. In addition, the configuration shown in the following embodiment is simply one example, and the present disclosure is not limited to the configuration that has been illustrated. Redundant explanations will be omitted by applying the same reference numerals to configurations that are the same or similar in the figures.

### (System Configuration)

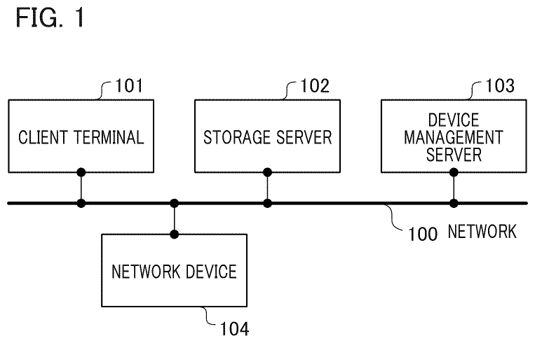

FIG. 1 is a diagram showing a configuration of a system according to a first embodiment. The system of the present embodiment is configured from a network 100, a client terminal 101, a storage server 102, a device management server 103, a network device 104, and the like.

The network device 104 is connected to the storage server 102 and the device management server 103 via the network 100, which is, for example, the internet, or the like. The network device 104 is a device that is a management target for the management server 103. The network device 104 is an image forming apparatus or an image processing apparatus such as, for example, a printer, a scanner, a multifunction peripheral that combines a printer and a scanner, or the like. Below, in order to simplify the description, there are also cases in which network device is shorted to “device”, and in addition, in which device management server is shortened to “management server”.

The network 100 is configured by at least one of a WAN (wide area network) and a LAN (local area network). For example, the internet can be used as the WAN. For example, an intranet can be used as the LAN.

In FIG. 1, although there is only one network device 104 shown, a plurality of devices 104 may also exist on a network for one customer organization. In addition, devices 104 for a plurality of customer organizations may also be connected to one storage server 102 and one management server 103. In this context, a “customer organization” is a company or the like that actually uses this device 104.

The client terminal 101 is a communications terminal that is operated by an operator of the sales organization. A web browser is installed on the client terminal 101. In this context, a “sales organization” is an organization that sells and installs a device 104 to a customer organization, and performs operations to a management service using the management server 103.

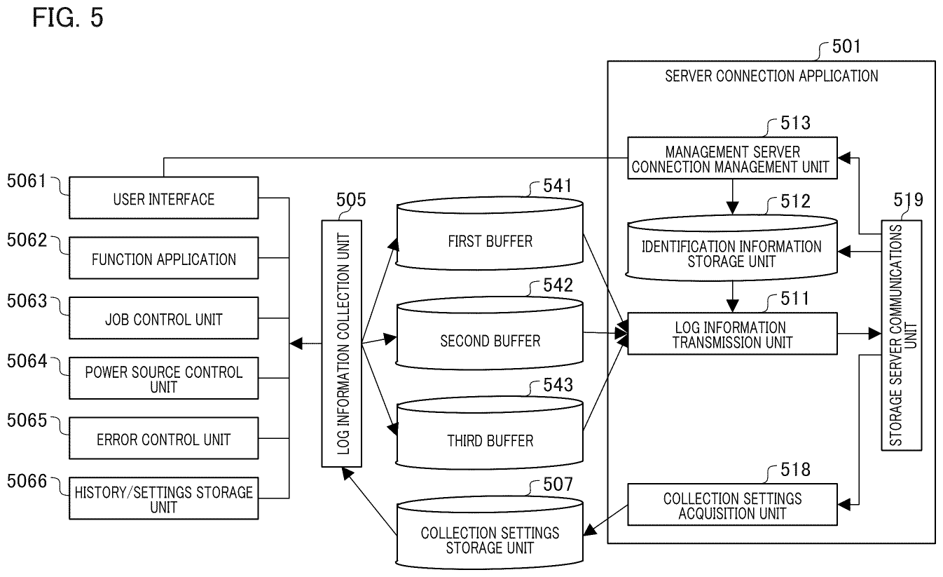

A server connection application 501 (explained below in FIG. 5) is installed on the network device 104. In addition, in a case in which the network device 104 performs device registration, and acquires access permission information for communicating with the storage server 102, connection to the management server 103 is performed by this server connection application 501. In addition, in a case in which the device 104 performs the acquisition of collection settings and the transmission of log information as well, connection to the storage server 102 is performed by this server connection application 501.

The storage server 102 and the management server 103 may physically be one device, or they may also be physically separate devices. Conversely, the storage server 102 and the management server 103 may also be a system that executes cloud computing.

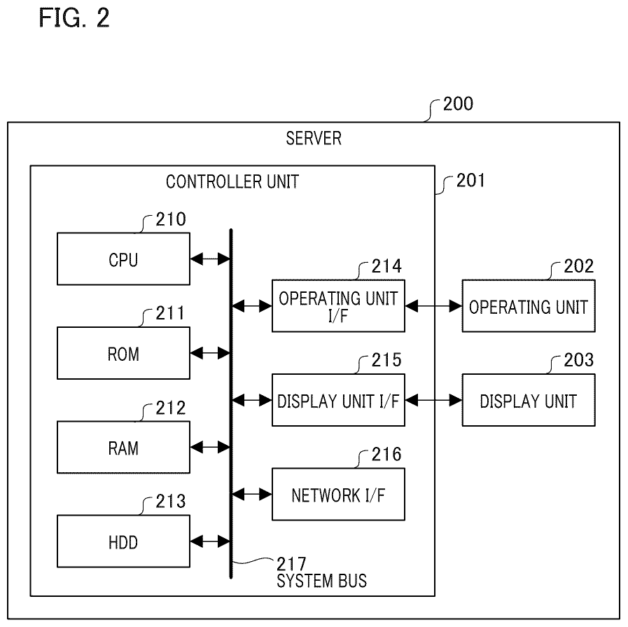

FIG. 2 is a diagram showing a hardware configuration that is shared within the servers of the present system, such as the storage server 102, the management server 103, and the like. These servers are made a server 200 in FIG. 2. The server 200 is provided with a controller unit 201, an operating unit 202, and a display unit 203. The controller unit 201 is provided with a CPU 210, a ROM 211, a RAM 212, an HDD 213, an operating unit I/F 214, a display unit I/F 215, and a network I/F 216. Each element within the controller unit 201 is connected to each other and performs data communications with each other via a system bus 217.

The CPU 210 (Central Processing Unit) integrally controls the server 200. The CPU 210 starts up an OS (Operating System) using a boot program that is stored on the ROM 211. In addition, the CPU 210 executes an application program that is stored on the HDD 213 on this OS, and thereby executes each type of processing.

The ROM (Read Only Memory) 211 is a non-volatile storage region, and stores each type of data such as the basic control program for the server 200, an OS (operating system), applications, and the like. A boot program is included in the basic control program.

The RAM (Random Access Memory) 212 is a volatile storage region, and is used as a temporary storage region for when the CPU 210 is performing each type of processing, and a work area. The CPU 210 expands each type of control program that has been stored on the ROM 211 and the HDD 213 onto the RAM 212.

The HDD (Hard Disk Drive) 213 is a non-volatile, large volume storage unit. The HDD 213 stores data such as application programs, settings values, log information that has been collected from the device 104 on the network 100, and the like. Note that although in the present embodiment, an HDD 213 has been explained as one example of a storage unit, the present disclosure is not limited thereto, and may also use an SSD (solid state drive), or this may also be any device that is able to read/write data by loading the external media of a memory card.

The operating unit 202 is, for example, a pointing device (for example, a mouse, a touch panel, or the like), an operating button, a keyboard, or the like, and receives operations, inputs, or commands from a user. The operating unit I/F 214 is an interface with the operating unit 202, and transmits information that has been input by a user using the operating unit 202 to the CPU 210.

The display unit 203 is, for example, a liquid crystal display, a touch panel, or the like, and displays an image or each type of data. The display I/F 215 outputs data to be displayed on the display unit 203 to the display unit 203. The operating unit 202 and the display unit 203 may also be configured together as a touch panel or the like.

The network I/F 216 is connected to the network 100, and performs the input and output of information between the device 104, the client terminal 101, and other servers on the network 100 via the network 100.

Note that the configuration of the server 200 that has been explained using FIG. 2 is one example of a case in which the server 200 has been realized by an information processing device such as general computer, or the like, and the present disclosure is not limited thereto. For example, the server 200 does not need to include the operating unit 202, the display unit 203, the operating I/F 214, and/or the display unit I/F 215.

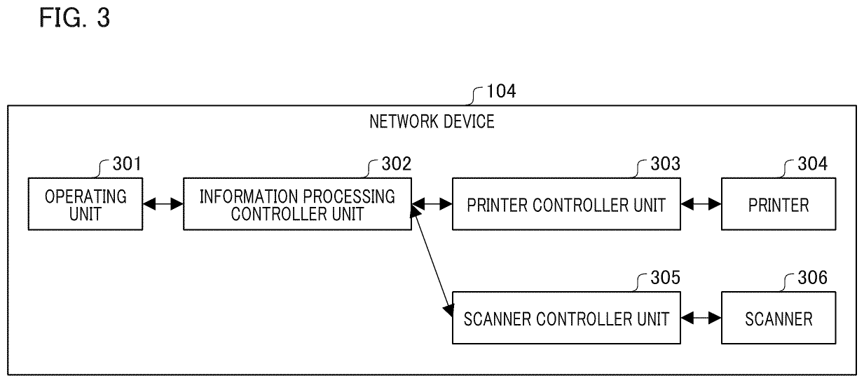

FIG. 3 is a diagram showing a simplified main hardware configuration of the network device 104. For example, the device 104 is explained as a multifunction peripheral. The device 104 includes an information processing controller unit 302, a printer controller unit 303, a scanner controller unit 305, a printer 304, a scanner 306, and an operating unit 301.

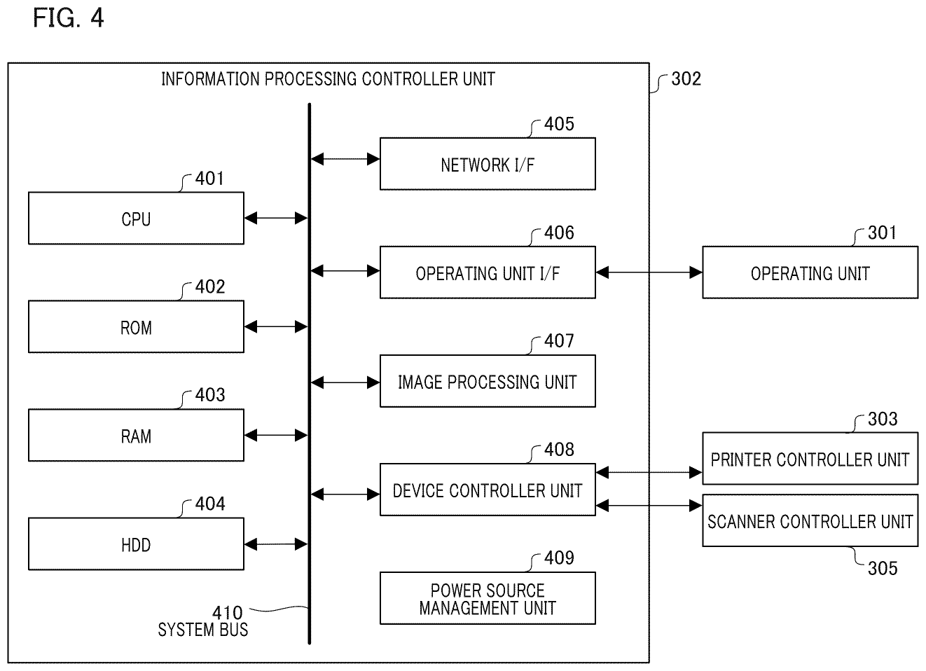

The information processing controller unit 302 is a controller that unifies the information processing control according to operations of the device 104. A detailed description of the information processing controller unit 302 will be given below using FIG. 4. The information processing controller unit 302 is connected to the operating unit 301, the printer controller unit 303, and the scanner controller unit 305.

The operating unit 301 is provided with a display device and an input device, and displays each type of information to the user, and also receives operations, inputs, and commands from the user. The display device is, for example, a liquid crystal display, and a touch panel. The input device is, for example, a pointing device (for example, a touch pad, a touch panel, or the like), an operating button, a keyboard, or the like. In the present embodiment, an example is explained of a case in which the device 104 is provided with a touch panel as the operating unit 301. By associating input coordinates on the touch panel with display coordinates, it is possible to configure a GUI such that the user is able to directly operate the screen that has been displayed on the touch panel instantly.

The printer 304 is an image output device that forms an image according to print data that has been received from an external unit and outputs this onto a sheet of paper, and optically reads an original image that has been set on the scanner 306 and outputs this onto a sheet of paper. The printer controller unit 303 controls the printer 304.

The scanner 306 is an image input device that optically reads an original document, and generates an electronic file (scan data) based on the scan. The scanner controller unit 305 controls the scanner 306.

FIG. 4 is a diagram showing a configuration of the information processing controller unit 302 of the device 104. The information processing controller unit 302 has a CPU 401, a ROM 402, a RAM 403, an HDD 404, a network I/F 405, an operating unit I/F 406, an image processing unit 407, a device controller I/F 408, and a power source management unit 409. Each element inside of the information processing controller unit 302 is connected via a system bus 410, and performs data communications with each other.

The CPU 401 controls the entirety of the device 104. Each type of processing that is explained below is executed by the CPU 401 starting up an OS using a boot program that is stored on the ROM 402, and executing an application program that is stored on the HDD 404 on the OS.

The ROM 402 is a non-volatile storage region, and stores each type of data such as a basic control program for the device 104, an OS (Operating System), applications, and the like. A boot program is included in the basic control program.

The RAM 403 is a volatile storage region, and is used as a temporary storage region for when the CPU 401 performs each type of processing, and as a work area. In addition, the RAM 403 provides an image memory region for temporary storage of image data. The CPU 401 expands each type of control program that has been stored on the ROM 402 and the HDD 404 onto the RAM 403. The CPU 401 realizes the functions of each block that is shown in FIG. 5 and executes the processing described below by executing a program that has been stored on a readable storage medium.

The HDD 404 is a non-voltage large-volume storage unit. The HDD 404 stores application programs, image data, each type of setting value, histories, and the like. Note that although the HDD 404 is explained as one example of the storage unit in the present embodiment, the present disclosure is not limited thereto, and the storage unit may also be an SSD, or the storage unit may also be a device that is able to read/write data by the insertion of an external media of a memory card.

The network I/F 405 is connected to the network 100, and performs the input and output of information between each device on the network 100 via the network 100, for example, between the storage server 102, and the management server 103.

The operating unit I/F 406 is an interface with the operating unit 301. The operating unit I/F 406 transmits information that has been input by a user using the operating unit 301 to the CPU 401, and in addition, outputs data to be displayed on the operating unit 301 to the operating unit 301.

The image processing unit 407 performs each type of image processing on an image that is output to the printer and an image that has been acquired by the scanner 306. As an example of each type of image processing, processing such as image rotation, image compression, resolution conversion, color space conversion, gradient conversion, and the like are given as examples.

The device controller I/F 408 is connected to the printer controller unit 303 and the scanner controller unit 305. The device controller I/F 408 controls the input and output of data between the printer controller unit 303 as well as the scanner controller unit 305 and the CPU 401. In addition, the device controller unit I/F 408 performs synchronous/asynchronous conversion of image data.

The power source management unit 409 performs power source control for the device 104. As a specific example, other than controlling the on/off states, the power source management unit 409 controls the transfer to power saving states other than the normal power state, and the return to a normal state, or the like.

Note that in FIGS. 2, and 4, the present disclosure is not limited to the CPU 210 and 401, and a PLD (Programmable Logic Device) such as an FPGA (Field Programmable Gate Array), or the like, may also be used. Conversely, an ASIC (Application Specific Integrated Circuit) may also be used, or a DSP (Digital Signal Processor) may also be used.

FIG. 5 is a diagram showing a software configuration for the network device 104. The functions of each block that are shown in the diagram are realized by the CPU 401 expanding a program that has been stored on the ROM 402 and the HDD 404 onto the RAM 403 and executing the program. The device 104 operates software that realizes the functions of a multifunction peripheral such a scanner, a printer or the like in addition to software that realizes the functions of a general information processing device using the network and memory storage.

The device 104 has a user interface 5061, a function application 5062, a job control unit 5063, a power source control unit 5064, an error control unit 5065, and a history/settings storage unit 5066. Furthermore, the device 104 has a log information collection unit 505, a first buffer 541, a second buffer 542, a third buffer 543, the server connection application 501, and a collection settings storage unit 507.

The server connection application 501 has a log information transmission unit 511, an identification information storage unit 512, a management server connection management unit 513, a collection settings acquisition unit 518, and a storage server communications unit 519.

The management server connection management unit 513 performs processing to register the device 104 to the management server 103 using a registration code. The registration code is, for example, input by the user via the user interface 5061. The management server connection management unit 513 acquires device identification information and stores device identification information on the identification information storage unit 512 by the device 104 being registered to the management server 103. The device identification information is unique identification information for identifying a device. The device 104 uses this device identification information and is able to establish a connection with the management server 103 and the storage server 102. There are also cases in which below, the device identification information is shortened to “identification information”.

The identification information storage unit 512 stores identification information. The identification information storage unit 512 stores the identification information, on, for example, the HDD 404, using a file format.

The storage server communications unit 519 performs communications processing with the storage server for the log information transmission unit 511 and the collection settings acquisition unit 518. The storage server communications unit 519 uses the identification information that has been stored on the identification information storage unit 512 and performs the acquisition of access permission information for the storage server 102 from the management server 103 before performing communications with the storage server 102.

In a case in which a notification that the owner of a device has changed is received when the storage server communications unit 519 acquires access permission information from the management server 103, the storage server communications unit 519 transmits this notification to the management server connection management unit 513. The owner is the owner of the device 104. The management server connection management unit 513 communicates with the management server 103 when a notification that the owner of the device has changed is received from the storage server communications unit 519, removes the current device registration, and registers the device, which is this device 104, as the device of the new owner. After this, the management server connection management unit 513 acquires identification information for this device as a device of the new owner. In a case in which the identification information that has been acquired is different from the identification information that is stored in the identification information storage unit 512, the identification information that has been acquired is overwritten and stored on the identification information storage unit 512.

The user interface 5061 displays a screen that is operated by a user on the operating unit 301, and transmits the operations of the user via the operating unit 301 to the software.

The function application 5062 operates the application functions of the multifunction peripheral. As application functions of the multifunction peripheral, there are a plurality of functions such as copying, printing, email transmission, and the like, and a function application 5062 is provided for each application function. That is, the device 104 has a plurality of function applications 5062. The function application 5062 operates the application functions of the multifunction peripheral using commands from the user via the operating unit 301, data reception via the network I/F 405, or the like as triggers.

The job control unit 5063 controls the printer controller unit 303 and the scanner controller unit 305 by receiving commands from the function application 5062, and executes printing and scanning.

The power source control unit 5064 controls the power source management unit 409 in conjunction with the state of the software inside of the device 104. As a specific example, the power source control unit 5046 controls the transition between a normal power state and an energy saving state according to the state of the software.

The error control unit 5065 detects abnormal states that occur in each unit inside of the device 104 such as the job control unit 5063, the printer controller unit 303, the scanner controller unit 305, and the like.

In addition, the error control unit 5065 sends commands such as halting an application and the entirety of the system, degeneracy operations, and the like, and controls the operation state of the device 104 in response to an abnormal state.

The history/settings storage unit 5066 manages nonvolatile information inside of the device 104. As a specific example, the history/settings storage unit 5066 stores the necessary settings to control the multifunction peripheral and the jobs, and summarizes then stores the user operation history, the job execution results, and/or the occurrence of errors, or the like. In addition, the history/settings storage unit 5066 also stores log information from the time of an error occurring in the system that remains for the purpose of analytical debugging. The nonvolatile data itself that is managed by the history/settings storage unit 5066 is stored on the HDD 404.

The log information collection unit 505 collects data such as the operation state or the like of the device 104 for transmission to the storage server 102, and stores this in the format of log information. Specifically, the log information collection unit 505 monitors events inside of the device 104, collects target data according to collection conditions that have been specified from the server connection application 501, and standardizes the collected data in the form of log data for transmission to the storage server 102. The log information collection unit 505 selectively stores the standardized log information on one of the first buffer 541 and the second buffer 542.

The collection of data inside of the device 104 by the log information collection unit 505 will now be explained. The log information collection unit 505 collects data inside of the device 104 according to collection settings for log information that have been stored in the collection settings storage unit 507, which will be described below. For example, the log information collection unit 505 monitors state transitions that have occurred in the modules that spontaneously raise events (for example, the user interface 5061 to the history/settings storage unit 5066), and collects the data for the state transitions in real time.

The log information collection unit 505 standardizes the data that has been collected inside of the device 104 in the form of log information, and stores the log information on the first buffer 541, the second buffer 542, or both of the first buffer 541 and the second buffer 542. The standardization is performed using a generic format such as, for example JSON (Java Script Object Notation), in order to make the data that has been collected a format that is transmitted to the storage server 102.

In addition to basic information such as the log information ID, the event name, the time at which an event occurred, the serial number for the device, and the like, various types of information are also additionally assigned to the log information based on the type of event. The assigned information is collected by the log information collection unit 505 from the state of each module inside of the device 104, the contents that are stored in the nonvolatile region, and the like. In addition, the conditions for determining whether to store the data that the log information collection unit 505 has collected in the first buffer 541, in the second buffer 542, or in both the first buffer 541 and the second buffer 542 are the conditions given below. That is, the conditions are the information for the collection settings that have been stored in the collection settings storage unit 507, and an internal determination of the log information collection unit 505.

In a case in which log information that is specified as a trigger for batch transmission has been stored on the second buffer 542 as the collection settings for the log information, the log information collection unit 505 generates trigger information, and stores the trigger information on the third buffer 543. Batch transmission of the log information from the second buffer 542 is executed based on the trigger information that has been stored on the third buffer 543. Batch transmission is transmitting a plurality of log information together (at substantially the same time) in a case in which a plurality of log information has accumulated.

In addition, the log information collection unit 505 has an internal timer function, and in the case of periodic transmission according to collection settings that have been stored on the collection settings storage unit 507 as well, the log information collection unit 505 stores trigger information. The trigger information includes the event name for the transmission target, the occurrence time for the transmission trigger (that is, the transmission time) information for the accumulation region for the log information from the second buffer 542 (for example, pass information for inside of the HDD 404), and the like. The trigger information is stored in a generic format such as JSON or the like.

The log information collection unit 505 is one example of a collection means that collects log information for events that occur inside of the network device 104.

The first buffer 541 and the second buffer 542 store log information that has been standardized by the log information collection unit 505. The first buffer 541 and the second buffer 542 are on the HDD 404. The data that is stored in the first buffer 541 (predominantly messages including log information that has been collected) can be transmitted in real time to the storage server 102 by the log information transmission unit 511. The data that is stored in the second buffer 542 (predominantly messages including log information that has been collected) can be batch transmitted to a storage server at a predetermined timing by the log information transmission unit according to the above-described trigger information. The second buffer 542 is one example of an accumulation means.

The third buffer 543 stores the trigger information that has been generated by the log information collection unit 505 as has been described above. The third buffer 543 is on the HDD 404.

The log information transmission unit 511 monitors the updates to the first buffer 541 and the third buffer 543. In a case in which these updates have been detected, the log information transmission unit 511 reads out the log information from the first buffer 541 and the second buffer 542, and transmits the log information to the storage server 102 via the storage server communications unit 519. The log information transmission unit 511 is one example of a transmissions unit that transmits accumulated log information to a server via the network 100.

The storage server communications unit 519 performs an upload region information (information relating to an upload region) acquisition request to the storage server 102, and acquires the necessary information for transmitting the log information directly before transmitting the log information to the storage server 102. Pass information such as a URL or the like, which necessary to determine the transmission destination for the log information, or a portion thereof is included in the upload region information.

In a case in which storage of new log information for the first buffer 541 has been detected, the log information transmission unit 511 reads out the log information that has been newly stored on the first buffer 541, and transmits this to the storage server 102 via the storage server communications unit 519.

In addition, in a case in which the storage of new trigger information for the third buffer has been detected, the log information transmission unit 511 reads out the new trigger information from the third buffer 543. In addition, the log information transmission unit 511 reads out the log information group that has been newly stored, and transmits this to the storage server 102 via the storage server communications unit 519 after the previous batch transmission inside of the second buffer 542 that was specified by the pass that is included in the trigger information that has been read out. At this time, log information for which the event occurrence time that is included in the log information for which transmission has been attempted is a time from before the storage time of the identification information to the identification information storage unit 512 is excluded from the transmission of log information. This is because this is log information that was generated during the contract period for a device owner who is different than the current owner of the network device. In this case, the log information transmission unit 511 is able to function as one example of a filtering means that performs filtering such that the log information for events that occurred before the contract start time is not transmitted to the sever.

The collection settings acquisition unit 518 receives the collection settings for the log information from the storage server 102 via the storage server communications unit 519, and stores the collection settings that have been received on the collection setting storage unit 507. In this context, the log information collection settings are contents that indicate definition information for what data from among the data inside the device 104 should be sent to the storage server 102 at what timing. The log information collection settings are acquired to serve as a collection filter.

The collection settings storage unit 507 stores information that shows the collection settings for the log information. The collection settings for the log information are stored in a file format. The collection settings storage unit 507 is on the HDD 404. The log information collection unit 505 stores log information on the first buffer 541 or the second buffer 542, and stores trigger information on the third buffer 543 based on the collection settings for the log information that have been stored on the collection settings storage unit 507.

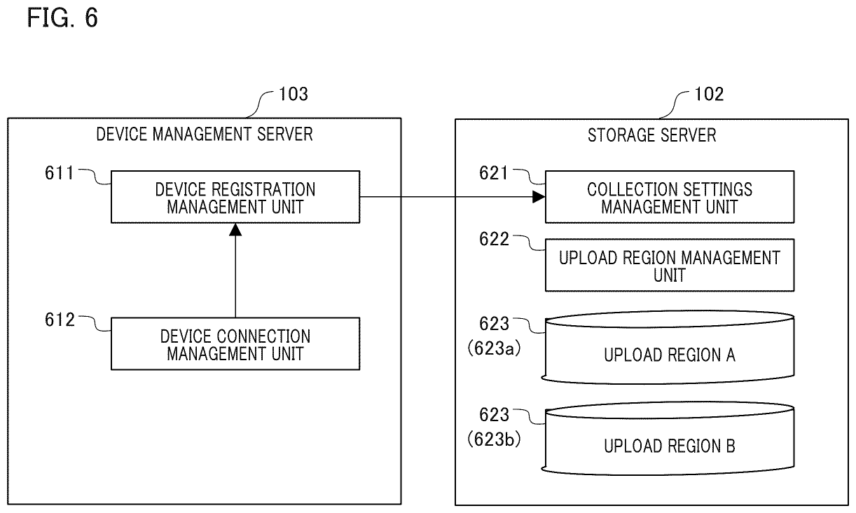

FIG. 6 is a block diagram showing the software configuration of the storage server 102 and the management server 103. The functions of each block are realized by the CPU 401 for each server expanding a program that has been stored on the ROM 402 and the HDD 404 on the RAM 403 and executing this.

Along with managing the identification information for arbitrary devices that are owned by a specific owner, a device registration management unit 611 performs registration and registration removal processing with respect to a specific owner for an arbitrary device 104 that is owned by this owner. In addition, the device registration management unit 611 performs the raising of identification information at the time of the registration of the device 104, and registers collection settings according to the contents of an information collection contract that has been signed between the owner and the sales organization in a collection settings management unit 621.

The information collection contract is a contract that is signed between the owner of the device 104 and principally the sales organization that sells the device 104. There are also cases in which in addition to the sale of the device, the sales organization also operates a cloud service that is linked to this device. Specifically, the information collection contract is a contract for uploading personal information such as the usage of the device or the like to the storage server 102 that is on a cloud managed by the sales organization. The usage of the device includes information such as, for example, “how many pages were printed, when, on what types of paper, on what sizes of paper, and how much ink was used”, or the like, which is information that is generated and recorded inside of the device. In addition, the information collection contract is strictly managed by the sales organization storing the personal information that has been uploaded in a logically exclusive region such that no one other than the current owner of the device is able to view it, or the like.

In the present embodiment, the contract begins with the agreement of both the sales organization and the owner of the device. For example, the contract begins at the timing at which device registration is performed to the management server 103, which is managed by the sales organization from the device that has been installed at the location of the customer (the owner), by using a device registration key that has been issued by the sales organization, and the device identification information is sent as a response. It is assumed that there is a sufficiently short gap in time between the contract start time at which the identification information has been sent as a response to the management server connection management unit 513 and the time at which the identification information is stored in the identification information storage unit 512 from the management server connection management unit 513. Therefore, the storage time for the identification information is treated as the contract start time.

The device connection management unit 612 performs processing that returns access permission information in response to an access permission information acquisition request to the storage server 102 from the storage server communications unit 519. In addition, the device connection management unit 612 sends a query to the device registration management unit 611 about the state of the identification information that is included in the acquisition request before returning the access permission information. In addition, the device connection management unit 612 returns a change of ownership notification instead of the access permission in a case in which there has been a change command for the owner who is linked to the device 104.

The collection settings management unit 621 performs management of the collection settings for each piece of identification information that has been registered from the device registration management unit 611. In addition, the collection settings management unit 621 returns collection settings that are linked to the identification information that is included in the acquisition request in relation to the collection settings acquisition request from the storage server communications unit 519.

An upload region management unit 622 performs management of the upload region for the log information for each piece of identification information inside of the storage server 102, and also performs response processing in relation to upload region information acquisition requests from the storage server communications unit 519. In a case in which the upload region management unit 622 performs response processing for an upload region information acquisition request, the upload region management unit 622 confirms the identification information that is included in the acquisition request, and newly allocates an upload region 623 that has been assigned to the identification information,

The upload region 623 stores the log information that has been transmitted from the device 104. The upload region 623 is on the HDD 213 inside of the storage server 102, and the log information is stored on the upload region 623 in a file format, or as data in a database.

An upload region 623 is allocated as a logically exclusive region for each device owner (each contract). For example, the upload regions 623 for the previous owner and a new owner of the same device 104 are both separated, and therefore, the logical regions of an upload region (A) 623a, and an upload region (B) 623b are allocated. The upload region 623 may also be allocated as a logically exclusive region for each piece of identification information and for each owner.

Note that in the hardware configuration for the storage server 102, in a case in which there is a plurality of writable nonvolatile storage devices that correspond to the HDD 213 and the like, the log information for each piece of identification information may also be allocated on logically exclusive regions on different storage devices.

### (Processing in the System)

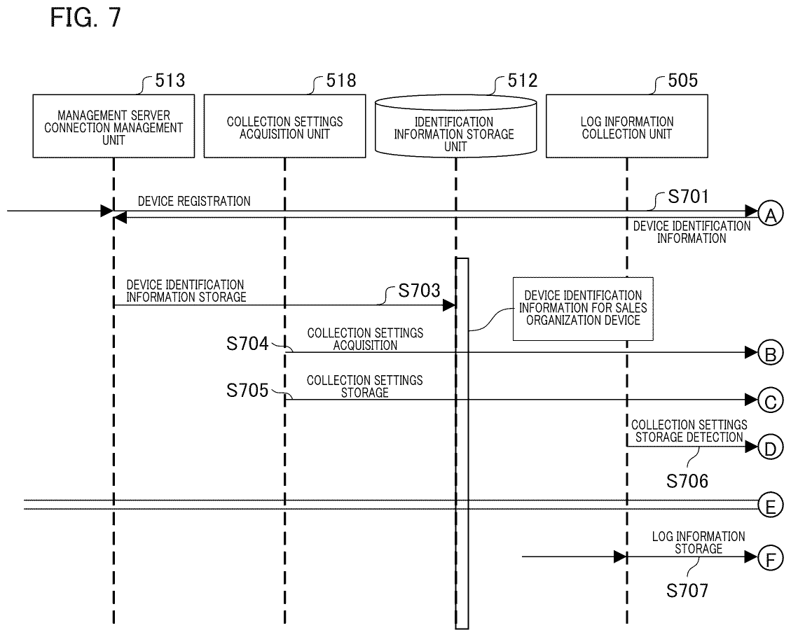

Next, an explanation will be given of the processing for the software in the system with respect to FIG. 7 to FIG. 14. In this context, it is explained that in a case in which the registration of the owner of the device 104 has been changed from the sales organization to a customer organization, the log information for the device of the sales organization that is stored on the second buffer 542 inside of the device 104 is not transmitted to the upload region for use by the customer organization. The present processing is realized by the CPU 210 reading out a program corresponding to the processing contents from the ROM 211 (or the HDD 213), and loading it and executing it on the RAM 212, and by the CPU 401 reading out a program corresponding to the processing contents from the ROM 402 (or the HDD 404), and loading it and executing it on the RAM 403.

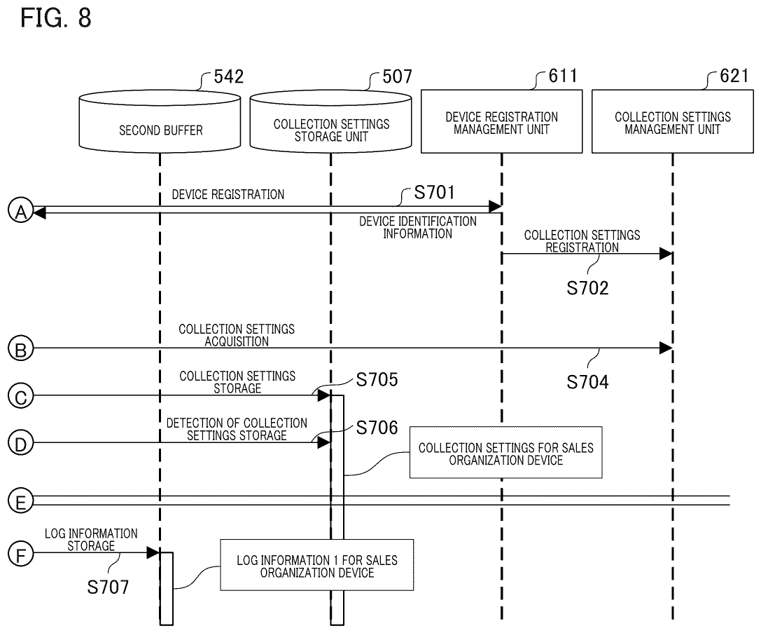

FIG. 7 and FIG. 8 are sequence diagrams showing the processing until device registration as a device owned by the sales organization, and the collection of log information inside of this device 104 begins for operation confirmation or the like. The portions inside of the diagram for which the lifetime is activated show that the data is being registered and stored. The arrows, which show commands, responses, the movement of data, or the like are connected between A to F in FIG. 7, and FIG. 8.

In S701 to S703, processing is performed in order to register the device 104 on the server. First, during S701, an employee of the sales organization inputs the device registration key for the sales organization into the management server connection management unit 513 via the user interface 5560 or the like of the device 104. The management server connection management unit 513 receives the input of the registration key from the device 104 and performs the registration of the device as a device for the sales organization in the device registration management unit 611. The device registration management unit 611 records the device identification information in an identification information management table that is shown below in the Table A. The management server connection management unit 513 acquires the identification information for the device of the sales organization in response to this device registration request.

The table A shows one example of an identification information management table that is managed by the device registration management unit 611.

TABLE A

| | Device Identification |
|---|---|
| Device Registration Key | Information |
| KEY000AA | aaa0000 |
| KEY000BB | bbb0001 |

The “device registration key” is key information that is unique within the management server 103, and in which there is a corresponding relationship between one device registration key and one owner. The “device identification information” is ID information for uniquely identifying a device inside of the management server 103 and the storage server 102.

In S702, the device registration management unit 611 registers collection settings for the device as a sales organization device to the collection settings management unit 621. The collection settings management unit 621 records the collection settings in a collection settings management table that is shown below in Table B.

The Table B shows one example of a collection settings management table that is managed by the collection settings management unit 621.

TABLE B

| Device Identification | Collection Target | Batch Transmission |
|---|---|---|
| Information | Log Information | Timing Trigger |
| aaa0000 | PrintCount, | Periodic transmission, |
| | PrintError | At the time of specific log |
| | | information generation |
| | | (Print Error) |

The “device identification information” is information that is the equivalent of the “device identification information” in table A. The “collection target log information” is information that shows the type of log information that is made a target for collection by the log information collection unit 505 inside of the device 104 that corresponds to this device identification information. The “batch transmission timing trigger” is information showing the timing at which the log information collection unit 505 generates trigger information in the third buffer 543. As the batch transmission timing trigger, there is, for example, a trigger that is generated at the time of the periodic transmission of log information, and a trigger that is generated at a time when specific log information is generated.

In S703, the management server connection management unit 513 stores identification information for the sales organization device that has been acquired during S701 on the identification storage unit 512.

During S704, the collection settings acquisition unit 518 acquires the collection settings for the sales organization device that has been registered in the collection settings management unit 621 during S702 due to the completion of S703.

During S705, the collection settings acquisition unit 518 stores the collection settings for the sales organization device that was acquired during S704 on the collection settings storage unit 507.

During S706, the log information collection unit 505 detects that the collection settings for the sales organization device have been stored in the collection settings storage unit 507 during S705, and begins the acquisition of log information according to the collection settings.

During S707, the log information collection unit 505 performs standardization of the log information in a case in which an event occurrence such as a state transition or the like of the user interface 5560 or the like has been detected. As was described above, the module for generating an event is not limited to the user interface 5560, and can also be any of the function application 5062 to the history/settings storage unit 5066. In addition, the log information collection unit 505 stores the standardized log information on the second buffer 542 as log information (1) for the sales organization device.

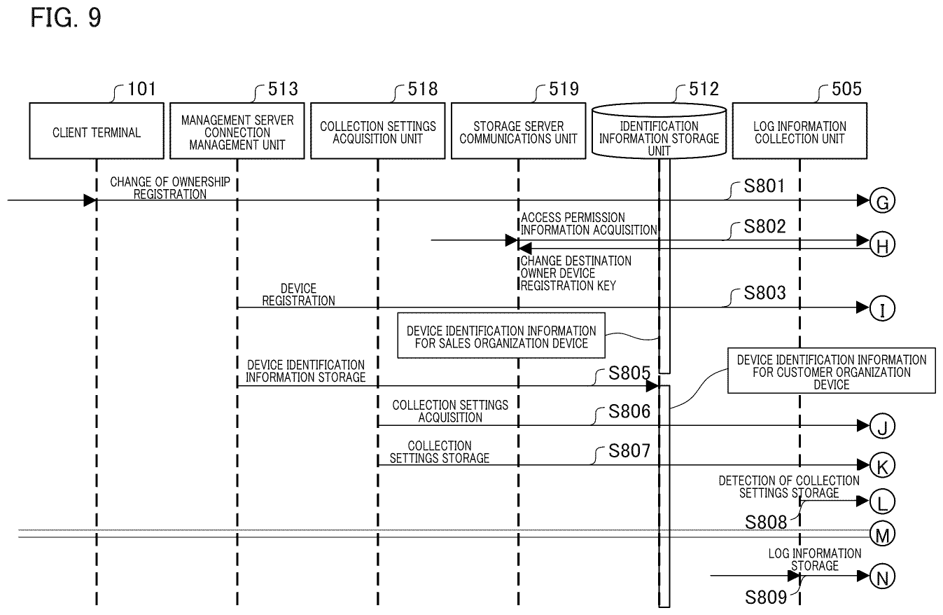

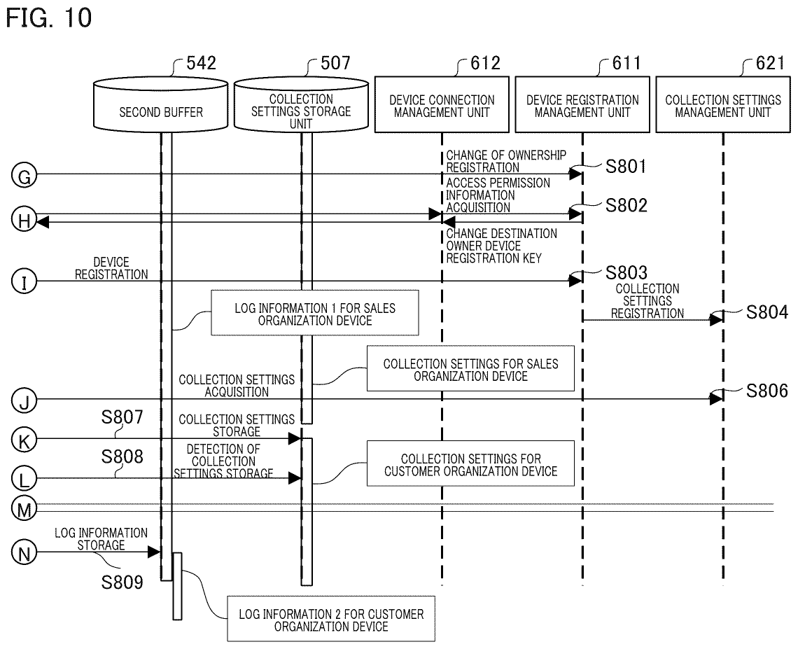

FIG. 9 and FIG. 10 are sequence diagrams that show the processing up until the owner of the device 104 is changed from the sales organization to the customer organization, and the collection of the log information inside of the device 104 that is owned by the customer organization begins. The locations inside the diagrams in which the lifetime is activated show that data is being registered and stored. As the prerequisite conditions for FIG. 9 and FIG. 10, it is necessary that the sequences for FIG. 7 and FIG. 8 have been completed.

During S801 to S805, processing for registering the device 104 to the sever (changing the registration) is performed. First, during S801, an employee of the sales organization registers a command to the device registration management unit 611 for changing the owner of the device 104 to the customer organization via the browser of the client terminal 101. The device registration management unit 611 registers the device owner change command to the owner change management table that is shown in Table C below.

The Table C shows one example of a collection settings management table that is managed by the collection setting management unit 621.

TABLE C

| | Change Destination Owner |
|---|---|
| Device Identification Information | Device Key |
| aaa0000 | KEY000BB |

The “device identification information” is information that is equivalent to the “device identification information” from the Table A. The “change destination owner device registration key” is information that is equivalent to the “device registration key” in Table A.

During S802, the server connection application 501 requests the acquisition of access permission information in order to perform arbitrary communications with the storage server 120 for the first time after S801. Specifically, upon the storage server communications unit 519 performing a request to acquire access permission information from the device connection management unit 612, the device connection management unit 612 confirms the change command for the owner with the device registration management unit 611. The owner change command was recorded during S801, and therefore, the device connection management unit 612 transmits not only the access permission information but also the change destination owner device key (table C) that serves as the owner change command to the management server connection management unit 513.

Upon the notification during S802 of the owner change from the device connection management unit 612, during S803, the management server connection management unit 513 registers this device as the customer organization device. Specifically, the management server connection management unit 513 performs device registration to the device registration management unit 611 by using the change destination owner device registration key that was transmitted during S802. The management server connection management unit 513 acquires the identification information for the customer organization device as the response to this device registration request.

During predominantly S701, S703, S803, S805, and the like, the management server connection management unit 513 is able to function as one example of a registration means that registers the network device 104 to the server.

During S804, the device registration management unit 611 registers the collection settings for the customer organization device to the collection settings management unit 621.

During S805, the management server connection management unit 513 stores the identification information that was acquired from the device registration management unit 611 during S803 on the identification information storage unit 512.

During S806, in the same manner as during S704, the collection settings acquisition unit 518 acquires the collection settings that are linked to the device 104 from the collection settings management unit 621. During S804, the collection settings for the customer organization device were registered to the collection settings management unit 621. Therefore, the collection settings that are acquired by the collection settings acquisition unit 518 during S806 also become the collection settings for the customer organization device.

During S807, the collection settings acquisition unit 518 stores the collection settings for the customer organization device that were acquired during S806 to the collection settings storage unit 507.

During S808, the log information collection unit 505 detects that the collection settings for the customer organization device have been stored in the collection settings storage unit 507, and starts the acquisition of log information according to the collection settings.

During S809, in the same manner as during S707, in a case in which the log information collection unit 505 has detected the occurrence of an event such as a state transition or the like for the user interface 5560 or the like, the standardization of the log information is performed. In addition, the log information collection unit 505 stores the log information (2) for the customer organization device in the second buffer 542.

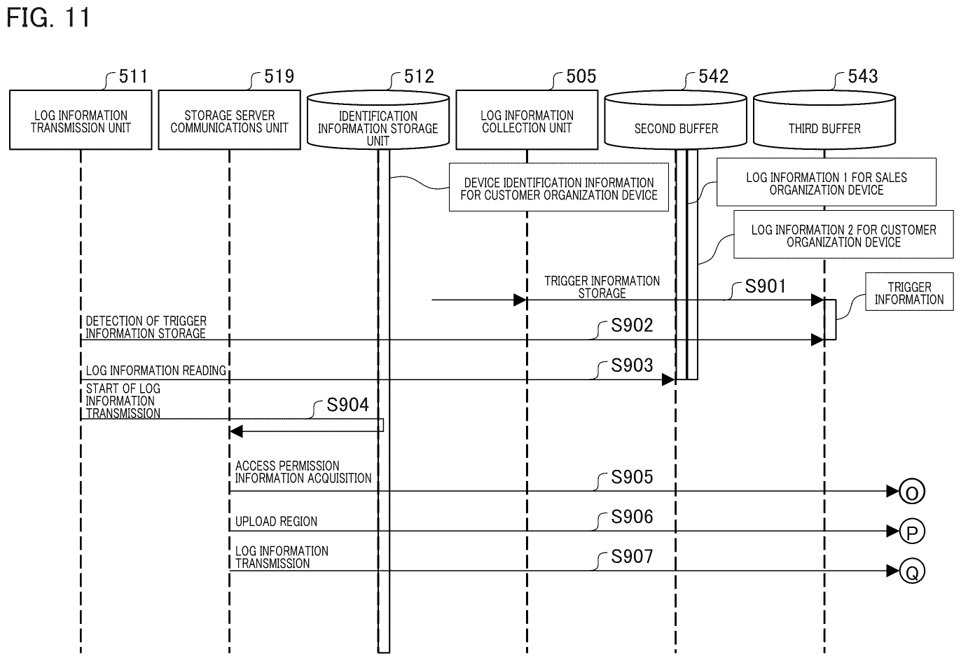

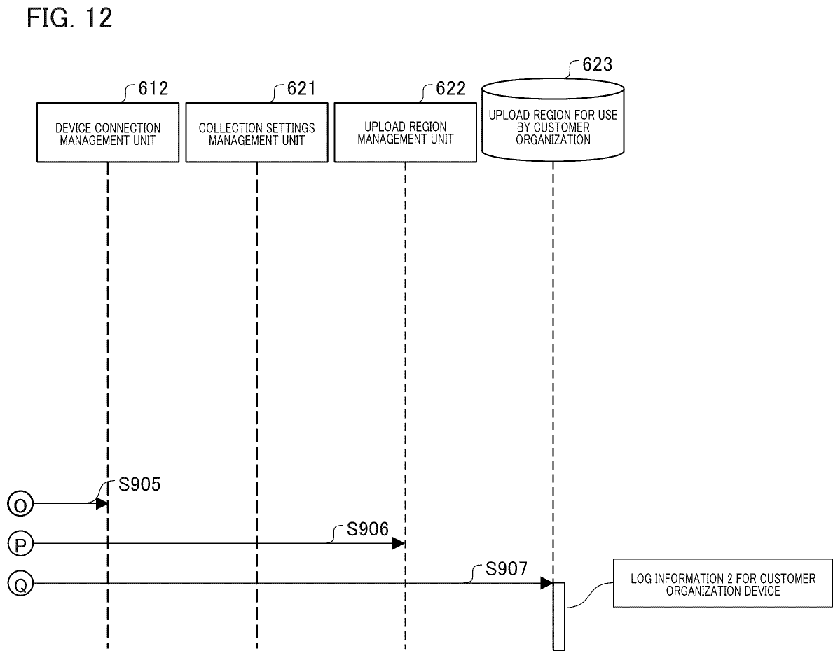

FIG. 11 and FIG. 12 are sequence diagrams showing the processing from the storage of the trigger information that has been created at a timing that is set by the collection settings, until the log information (2) for the customer organization device is transmitted to the upload region 623 for use by the customer organization. The upload region for use by the customer organization is, for example, the upload region 623b from FIG. 6, and the upload region for the previous owner of the device is the upload region 623a. The locations inside the diagram in which the lifetime is activated show that data is being registered and stored. As the prerequisite conditions for FIG. 11 and FIG. 12, it is necessary that the sequences of FIG. 9 and FIG. 10 have been completed.

During S901, the trigger information that the log information collection unit 505 has generated at the timing that has been set by the collection settings is stored on the third buffer 543. There are largely two patterns for the timings at which trigger information is generated inside of the log information collection unit 505. First is the timing at which the log information that is set as a trigger for the batch transmission timing inside of the collection settings is stored by the log information collection unit 505 in the second buffer 542. The other is the timing at which an internal timer inside of the log information collection unit 505, which has been determined by the collection settings, is triggered (the time for the internal timer reaches the designated time).

During S902, the log information transmission unit 511 detects that the trigger information has been stored in the third buffer 543. In addition, the log information transmission unit 511 acquires this trigger information that has been newly stored from the third buffer 543.

During S903, the log information transmission unit 511 reads the log information that has not yet been transmitted from the second buffer 542 based on the pass information that is written in the trigger information that was acquired during S902. As was shown in FIG. 7 to FIG. 10, the second buffer 542 stores the log information (1) for the sales organization device and the log information (2) for the customer organization device as log information that has not yet been transmitted. Therefore, in the case of the example of FIG. 11 and FIG. 12, the log information transmission unit 511 reads both the log information (1) and the log information (2).

During S904, the log information transmission unit 511 transmits the log information that has been read. As the internal processing for S904, the log information transmission unit 511 reads the identification information from the identification information storage unit 512. In addition, the log information transmission unit 511 compares the storage time for this identification information and the generation time for each log information that has been read from the second buffer 542, and removes log information that has a generation time from before the storage time for the identification information from the transmission target. In the example of FIG. 11 and FIG. 12, the generating time for the log information (1) for the sales organization device is from before the storage time for the device identification information that is stored in the identification information storage unit 512. Therefore, this log information (1) is removed from the transmission target, and the transmission of the log information (2) for the customer organization device begins.

During S905, the storage server communications unit 519 acquires the access permission information from the device connection management unit 612. This access permission information is for the transmission of the log information (2) for the customer organization device to the storage server 102, for which the transmission began during S904.

During S906, the storage server communications unit 519 acquires the upload region information from the upload region management unit 622 using the access permission information that was acquired during S905. Specifically, by transmitting an acquisition request for the upload region information, the storage server communications unit 519 acquires the upload region information. The upload region management unit 622 confirms the identification information that is included in the upload region information acquisition request that has been received from the storage server communications unit 519. The upload region management unit 622 newly allocates the upload region 623b for use by the customer organization in the case in which the upload region 623 for use by the corresponding customer organization has not yet been allocated.

During S907, the storage server communications unit 519 uses the access permission information that was acquired during S905 and the upload region information that was acquired during S906 and uploads the log information (2) for the customer organization device to the upload region 623b.

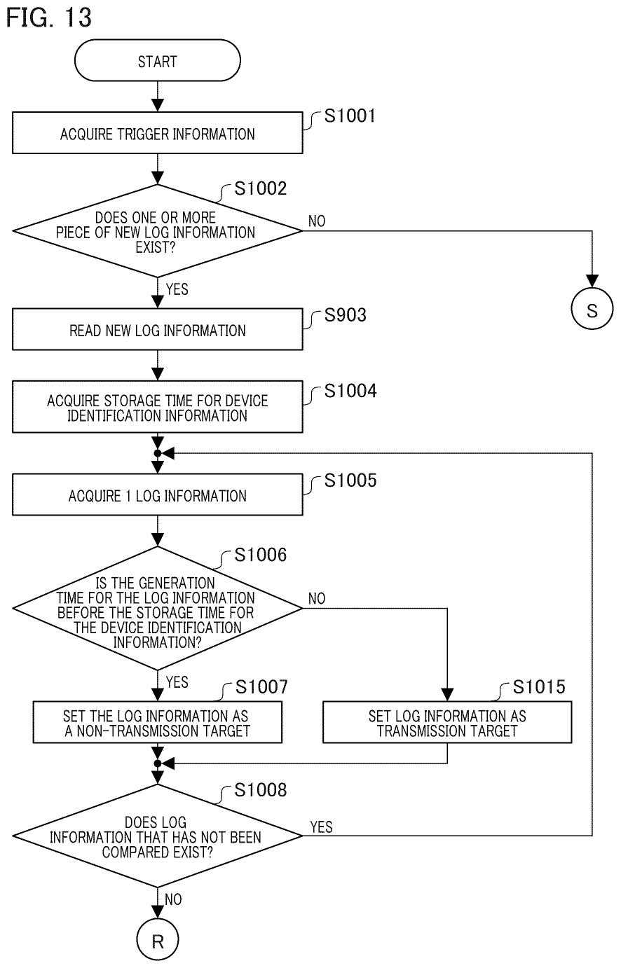

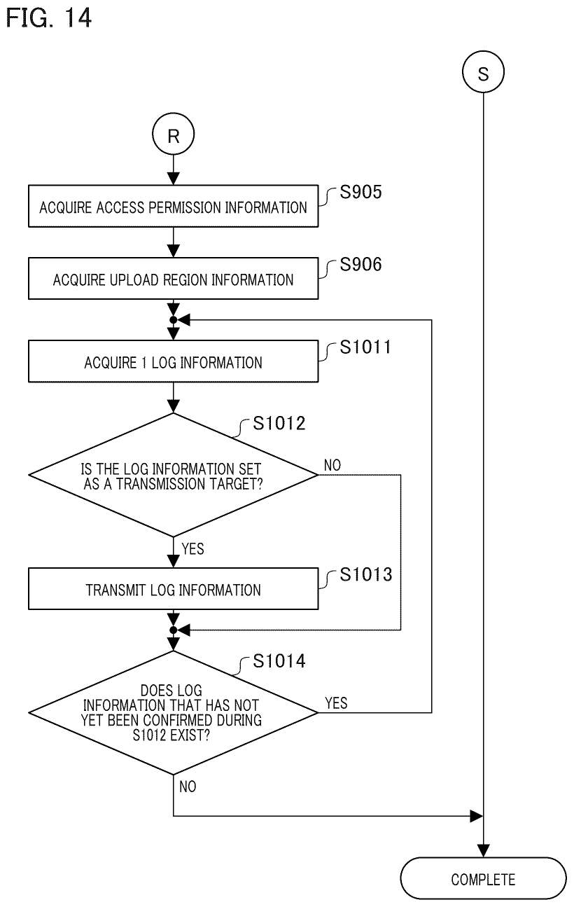

FIG. 13 and FIG. 14 are flowcharts showing batch transmission processing for the log information that has been stored on the second buffer 542, which is executed by the device 104. Specifically, the processing in FIG. 13 and FIG. 14 corresponds to the processing from S902 until S907 from FIG. 11 and FIG. 12. The present processing is realized by the CPU 401 reading out a program corresponding to the processing contents from the ROM 402 or the HDD 404 and then loading and executing this on the RAM 403

During S1001, the log information transmission unit 511 acquires the trigger information for which the storage of was detected during S902 from the third buffer 543.

During S1002, the log information transmission unit 511 references the region information for the second buffer 542 that is included in the trigger information that was acquired during S1001, and accesses the second buffer 542. In addition, the log information transmission unit 511 determines whether or not one or more pieces of new log information that have not yet been processed exist inside of the second buffer 542.

In a case in which one or more pieces of new log information is included, during S903, the log information transmission unit 511 reads this new log information. In a case in which one or more pieces of new log information is not included, contents to be transmitted do not exist, and therefore, the batch transmission processing is completed.

During S1004, the log information transmission unit 511 acquires the storage time at which the device identification information was stored in the identification storage unit 512 during S805.

During S1005, the log information transmission unit 511 acquires an arbitrary piece of log information that has yet to be acquired (that was not acquired during a previous S1005) from among the new log information group that has been acquired from the second buffer 542 during step S903.

During S1006, the log information transmission unit 511 determines whether or not the generation time for the log information that was acquired during S1005 was before the storage time for the identification information that was acquired during S1004.

In the case of Yes during S1006, during S1007, the log information transmission unit 511 registers this log information as a non-transmission target in a log information transmission target table to be described below that is temporarily generated only during the period for the present batch transmission processing. In the case of No during S1006, during S1015, the log information transmission unit 511 registers this log information as a transmission target in the log information transmission target table.

Table D shows an example of a log information transmission target table that is temporarily generated only during the batch transmission processing by the log information transmission unit 511.

TABLE D

| Log Information ID | Transmission Target Type |
|---|---|
| Log0 | Non-transmission target |
| Log1 | Transmission target |

The “log information ID” is identification information that is unique within the batch transmission processing period inside of the log information transmission unit 511 and that is linked to one piece of log information. The “transmission target type” is flag information that identifies whether or not the log information corresponding to a log information ID will become a transmission target. The value for the transmission target type has two values, “transmission target” and “non-transmission target”.

During S1008, the log information transmission unit 511 determines whether or not log information for which a comparison of the generating time has not been performed during a previous S1008 exists inside of the new log information group that was acquired during S903. In the case of Yes during S1008, the log information transmission unit 511 performs the processing for S1005.

In the case of No during S1008, the log information transmission unit 511 determines that the log information transmission target table has been completed, transmits the log information transmission target table and the new log information group that was acquired during S903 to the storage server communications unit 519, and performs the processing for S905 and S906. The processing contents for S905 and S906 have been previously explained, and therefore, an explanation thereof will be omitted.

During S1011, the storage server communications unit 519 acquires an arbitrary piece of log information that was not acquired during a previous S1011 from among the new log information group that was acquired from the second buffer 542 during S903.

During S1012, the storage server communications unit 519 references the log information transmission target table and determines whether or not one piece of log information that was acquired during S1011 is a transmission target.

In the case of Yes during S1012, during S1013, the storage server communications unit 519 uses the access permission information that was acquired during S905, and the upload region information that was acquired during S906, and transmits the target log information to the upload region 623b for use by the customer organization.

In the case of No during S1012, during S1014, the storage server communications unit 519 determines whether or not log information for which a determination was not performed during S1012 exists inside of the new log information group that was acquired during S903.

In the case of Yes for S1014, the storage server communications unit 519 performs the processing for S1011. In the case of No during S1014, the present batch transmission processing is completed.

As was explained above, upon the device registration for the owner of the device 104 being changed from the sales organization to the customer organization, during S904, the log information (1) for the sales organization device is excluded from the transmission targets. It is thereby possible to make it such that the log information for the sales organization device that is stored on the second buffer 542 inside of the device is not transmitted to the upload region for use by the customer organization. As a result, it is possible to transmit only the log information (2) for the current owner of the device to the upload region for the device of the current owner in a device for which an ownership change has been performed. That is, the present system is able to appropriately and strictly manage log information that has been generated during the contract period by the previous owner, and is able to suppress the risk of a leak of personal information.

In addition, in the provisional case of only real time processing via the first buffer 541 without using the second buffer 542, the number of connections to the server will increase proportionately to the number of events, and therefore, the cost will also increase. By performing batch transmission at an arbitrary timing using the second buffer 542, it is possible to suppress such an increase in costs.

### Other Embodiments

For example, although in the above-described embodiment the start time for the contract was made the time at which the identification information is stored (for example, S703, and S805), the present disclosure is not limited thereto. The start time for the contract may be any time as long as this is a time within the period during which device registration processing is performed (the time of registration). The period in which the device registration processing is performed is, for example, S701 to S703, and S801 to S805.

In the above-described embodiment, an example has been explained in which as the owner of the device 104, the owner has changed from the sales organization to the customer organization. However, the present disclosure may also be applied in the same manner to a change in ownership from a customer organization to another customer organization, or to a change in ownership within the same customer organization.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-3418, filed Jan. 12, 2024, which is hereby incorporated by reference herein in its entirety.

What is claimed is:

1. A network device that is allowed to be connected to a server via a network, the network device comprising:
a memory storing instructions; and
a processor executing the stored instructions causing the network device to:
collect log information for an event that occurs inside of the network device;
accumulate the collected log information;
transmit the accumulated log information to the server via the network; and
compare a time of occurrence for the event with a contract start time for a current ownership contract for the network device, and perform filtering such that the log information for one or more events that occurred before the contract start time among the accumulated log information is not transmitted to the server.

2. The network device according to claim 1, wherein execution of the stored instructions by the processor further causes the network device to perform processing to register the network device to the server; wherein
the contract start time is a time at which the network device was registered to the server.

3. The network device according to claim 2 wherein execution of the stored instructions by the processor further causes the network device to: acquire and store identification information that identifies the network device from the server; and wherein
the contract start time is a time at which the identification information is stored.

4. The network device according to claim 2, wherein execution of the stored instructions by the processor further causes the network device to:
request an acquisition of information relating to an upload region for the log information within the server;
acquire and store identification information that identifies the network device from the server; and
by transmitting the log information, store the log information on the upload region, which is allocated inside of the server, that corresponds to the identification information.

5. The network device according to claim 1, wherein the execution of the stored instructions by the processor further causes the network device to:
generate trigger information including at least a transmission time; and
transmit the accumulated log information to the server based on the trigger information.

6. The network device according to claim 5, wherein the trigger information further includes at least one of a name for the event that corresponds to the log information that is a transmission target, and information for an accumulation region for the log information.

7. The network device according to claim 1, wherein the network device is a printing device, a scanner, or a multifunction peripheral.

8. An information processing method for a network device that is allowed to be connected to a server via a network, the method comprising:
collecting log information for an event that occurs inside of the network device;
accumulating the collected log information;
transmitting the accumulated log information to the server via the network; and
comparing a time of occurrence for the event with a contract start time for a current ownership contract for the network device, and performing filtering such that log information for one or more events that occurred before the contract start time among the accumulated log information is not transmitted to the server.

9. A non-transitory storage medium storing a control program of a network device causing a computer to perform each step of an information processing method for the network device, the method comprising:
collecting log information for an event that occurs inside of the network device;
accumulating the collected log information;
transmitting the accumulated log information to the server via the network; and
comparing a time of occurrence for the event with a contract start time for a current ownership contract for the network device, and performing filtering such that log information for one or more events that occurred before the contract start time among the accumulated log information is not transmitted to the server.
